(19) United States
(12) Patent Application Publication
(10) Pub. No.: US 2026/0067452 A1
(43) Pub. Date: Mar. 5, 2026

(54) Methods and Devices for Creating a Bit Rate Ladder for Video Streaming

(71) Applicant: Hochschule RheinMain, Wiesbaden (DE)

(72) Inventors: Matthias Narroschke, Schaafheim (DE); Andreas Kah, Kelsterbach (DE); Klein Maurice, Mainz (DE); Ruppel Wolfgang, Frankfurt (DE)

(21) Appl. No.: 19/104,179

(22) PCT Filed: Aug. 14, 2023
(86) PCT No.: PCT/EP2023/072400

§ 371 Date: Feb. 14, 2025

(30) Foreign Application Priority Data
Aug. 17, 2022 (DE) 10 2022 120 724.2

(51) Int. Cl. H04N 19/115; H04N 19/136; H04N 19/42

(52) U.S. Cl. CPC H04N 19/115; H04N 19/136; H04N 19/42

(57) ABSTRACT

The present disclosure relates to methods and devices for creating a bit rate ladder for encoding representations of a video section. Creating includes generating a set of reference points, where a reference point indicates a quality of a representation based on the bit rate and the resolution. A subset of reference points is selected to create the bit rate ladder while taking quality requirements into account.

### CROSS-REFERENCE TO RELATED APPLICATIONS

This application is the United States national phase of International Patent Application No. PCT/EP2023/072400 filed Aug. 14, 2023, and claims priority to German Patent Application No. 10 2022 120 724.2 filed Aug. 17, 2022, the disclosures of each of which are hereby incorporated by reference in their entireties.

### BACKGROUND

### Technical Field

The present disclosure relates to methods and devices for creating a bit rate ladder for encoding representations of a video section.

### Technical Considerations

When transmitting video data, the quality of the video depends on the bit rate. The amount of data that is required can be so large that difficulties can arise when transmitting data over networks with limited bandwidth. Examples of this are broadcasting a digital television program and transmitting image/video over the Internet or mobile networks.

Despite the typical compression of image or video data before it is stored or transmitted over a network, the amount of data of a quality of the video often cannot be reduced sufficiently for networks with limited bandwidth.

Streaming services therefore typically provide several versions of the same video, each with a different quality level. These different versions of the same video are also called representations of a video. They have bit rates that differ from one another. The different bit rates are obtained by different settings of the encoding parameters in the encoder. For example, the quantization step width can be set differently for different representations. The set of representations is referred to as a bit rate ladder.

### SUMMARY

Since the desired image quality should be as high as possible, it is therefore desirable to adapt the selection of the bit rate to the bandwidth available to the user without having to accept significant losses in image quality. It is therefore an object of the present disclosure to efficiently create a bit rate ladder that meets predetermined quality requirements.

This object is satisfied by the disclosure herein and includes advantageous embodiments.

Some non-limiting embodiments of the present disclosure allow for a set of representations of video sections to be created in such a way that the maximum quality difference in a quality measure is minimized while taking into account the costs for encoding and storage.

According to a first non-limiting aspect, the present disclosure relates to a method for creating a bit rate ladder for encoding representations of a video section. The method comprises determining a first set of reference points, where a reference point indicates a quality of a representation based on the bit rate and the resolution and the quality is based on a comparison with an original representation. The method furthermore comprises creating a second set of reference points based on the first set of reference points, where the second set comprises more reference points than the first set. The method furthermore comprises selecting a subset of reference points of the second set while taking quality requirements into account for creating the bit rate ladder based on the subset of reference points.

According to some non-limiting embodiments of the present disclosure, determining the first set of reference points can comprise selecting a first grid of pairs of values in a bit rate resolution space and determining qualities of representations at the pairs of values of the first grid in order to obtain a first set of reference points.

In some non-limiting embodiments, the first grid can comprise at least the predetermined pairs of values
maximum bit rate, maximum resolution, and
minimum bit rate, minimum resolution
   where the minimum bit rate for the minimum resolution is determined taking into account quality requirements, the maximum bit rate for the maximum resolution is determined taking into account quality requirements, the maximum resolution corresponds to a resolution of the original representation, and the minimum resolution corresponds to a predetermined resolution that is lower than the resolution of the original representation.

For example, the quality requirements can comprise at least two target quality levels that correspond to a minimum target quality and a maximum target quality. Furthermore, a quality of a representation that is created based on the minimum bit rate and the minimum resolution can fall below the minimum target quality, and a quality of a representation that is created based on the maximum bit rate and the maximum resolution can exceed the maximum target quality.

In some non-limiting embodiments, creating the second set of reference points can further comprise creating a second grid of pairs of values in a bit rate resolution space comprising pairs of values of the first set, and creating qualities for the pairs of values of the second set based on the reference points of the first set.

According to some non-limiting embodiments, creating qualities for the pairs of values of the second set can comprise at least one of the following:
interpolation of the sampling points, and/or
processing by a neural network, and/or
a combination thereof.

For example, processing by a neural network can comprise obtaining reference points of the first set or an interpolation of reference points of the first set as input data, and creating output data comprising processing the input data by one or more layers of the neural network.

In some non-limiting embodiments, output data of the neural network can be processed by filtering the output data to comply with monotonicity conditions and/or limiting the value range of the predicted qualities.

For example, the quality requirements can comprise at least two target quality levels that correspond to a minimum target quality and a maximum target quality. Furthermore, selecting the subset of reference points for each target quality level from the quality requirements can comprise determining a bit rate for a bit rate specification of an encoder. Furthermore, determining a bit rate for a bit rate specification can comprise determining a bit rate for each resolution whose associated predicted quality meets the quality requirements for the respective target quality level and selecting the minimum bit rate from the determined bit rates as the bit rate specification.

In some non-limiting embodiments, determining the bit rate for the bit rate specification can comprise an interpolation based on the reference points of the second set.

For example, selecting the subset of reference points can comprise creating a representation comprising encoding the video section with the respective bit rate specification for each target quality level from the quality requirements.

In some non-limiting embodiments, the method can further comprise determining a quality of the representation created and comparing the quality determined with the quality requirements. If the quality determined meets the quality requirements, then the method can further comprise comprising the representation in the bit rate ladder. If the quality determined does not meet the quality requirements, then the method can further comprise determining a new representation based on a new bit rate specification.

According to a second non-limiting aspect, the present disclosure further relates to a method for encoding representations of a video section. The method comprises the above-mentioned creation of a bit rate ladder, where the bit rate ladder comprises two or more quality levels. The method furthermore comprises creating a representation for each of the quality levels of the bit rate ladder, where creating the representation comprises encoding the video section according to the respective quality level.

According to some non-limiting embodiments, a computer program is provided which comprises program instructions stored on a non-transferable, computer-readable medium and which, when executed on one or more processors, cause the one or more processors to carry out the steps of one of the above-mentioned methods.

According to a third non-limiting aspect, the present disclosure further relates to a device for creating a bit rate ladder for encoding representations of a video section. The device comprises a unit for determining a first set of reference points, where a reference point indicates a quality of a representation based on the bit rate and the resolution and the quality is based on a comparison with an original representation. The device furthermore comprises a unit for creating a second set of reference points based on the first set of reference points, where the second set comprises more reference points than the first set. The device furthermore comprises a unit for selecting a subset of reference points of the second set while quality requirements taking into account for creating the bit rate ladder based on the subset of reference points.

According to a fourth non-limiting aspect, the present disclosure further relates to a device for encoding representations of a video section. The device comprises an above-mentioned device for creating a bit rate ladder. The device furthermore comprises a unit for creating a representation for each of the quality levels of the bit rate ladder, where creating the representation comprises encoding the video section according to the respective quality level.

Additional advantages and benefits of the present disclosure shall become apparent from the detailed description of a preferred embodiment and the drawings.

### BRIEF DESCRIPTION OF THE DRAWINGS

The terms Fig., Figs., Figure, and Figures are used interchangeably in the specification to refer to the corresponding figures in the drawings.

FIG. 1 shows a block diagram of an exemplary device for determining a bit rate ladder.

FIG. 2 shows exemplary relationships between the bit rate and the quality.

FIG. 3 shows examples of the quality loss and the maximum quality loss in a quality-bit rate diagram.

FIG. 4 shows an exemplary classification into quality levels.

FIG. 5 shows an exemplary determination of the maximum quality level.

FIG. 6 shows examples of the acceptance rate and the VMAF score for video sections longer than 30 seconds.

FIG. 7 shows examples of the acceptance rate and the VMAF score for video sections shorter than 30 seconds.

FIG. 8 shows the dependency determined between the MOS and the VMAF score.

FIG. 9 shows an exemplary classification into quality levels based on the VMAF score.

FIG. 10 shows an exemplary block diagram of a scaler and encoder.

FIG. 11 shows an exemplary flow chart for creating a bit rate ladder.

FIG. 12 shows an exemplary flow chart for determining a first set of reference points.

FIG. 13 shows an exemplary flow chart for determining a second set of reference points.

FIG. 14 shows an exemplary flow chart for selecting representations based on the second set.

FIG. 15 shows by way of example a first set of reference points.

FIG. 16 shows by way of example a second set of reference points.

FIG. 17 shows schematically the structure of a neural network for creating estimated quality values.

FIGS. 18a-d show schematically the monotonicity filtering of estimated qualities.

FIG. 19 shows by way of example a linear interpolation of reference points of the second set for a constant spatial resolution.

FIG. 20 shows by way of example a selection of a bit rate specification in a target region.

FIG. 21 shows by way of example a created bit rate ladder in the bit rate resolution space.

FIG. 22 shows an exemplary device that can execute program instructions.

### DETAILED DESCRIPTION

In the following, a non-limiting embodiment of the present disclosure shall be described in detail with reference to the drawings.

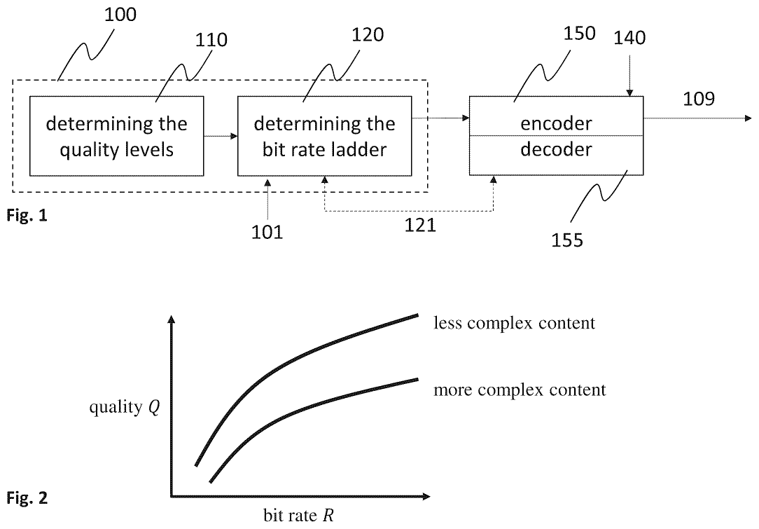

FIG. 1 shows a device 100 for determining a bit rate ladder that can be used to encode a video sequence 140 into a plurality of representations 109 of different quality levels. Such a bit rate ladder can be determined individually for each video or for each video section. However, it can also be determined once and then used as a template for encoding a plurality of video sequences. The encoding is carried out by encoder 150. Encoder 150 can be a standardized encoder, such as H.264/AVC (“Advanced Video Coding”), H.265/HEVC (“High-Efficiency Video Coding”), H.266/VVC (“Versatile Video Coding”), or AV1 (“AOMedia Video 1”). The present disclosure can be used with any encoders, as long as they can be parameterized so that a desired bit rate and/or quality of the encoded video sequence can be set using one or more encoding parameters.

A video sequence 140 is a sequence of a plurality (two or more) of images which can also be referred to in short as “video” or “video signal”. The term “video section” is also used hereinafter to emphasize that a video sequence to be encoded, for example a film, does not necessarily have to be encoded in its entirety, but in one or more sections. On the one hand, a video section can be a temporal section, i.e., a subset of the total number of images in a video sequence. However, a video section can instead or additionally be a spatial section, e.g., a subpicture of an overall image.

Device 100 for determining a bit rate ladder can comprise, for example, a device 110 for determining the quality levels.

Alternatively, device 100 for determining a bit rate ladder can receive, for example, predetermined quality requirements as input parameters.

In this case, quality is measured by a predefined quality metric. Preferably, the quality metric has a correlation with the quality perceived by viewers. Determining the quality levels comprises determining a quality range in which the plurality of representations should be located and the levels themselves (number and/or distribution of the levels in the quality range).

Once the quality levels have been determined, the bit rate ladder can be determined in a device 120 on the basis of the determined quality requirements, which comprise the quality levels. This can be done, for example, for a specific codec. However, it is generally also possible to use different codecs for certain quality levels. It can be advantageous to encode the representations of a bit rate ladder that are associated with high quality using a more efficient codec in terms of encoding efficiency than the representations that are associated with low quality. If the less efficient codec is associated with a shorter encoding time, this can reduce the encoding time.

A bit rate ladder is a set of representations, each associated with a bit rate and a spatial resolution corresponding to the respective predetermined (in device 110) quality levels. For example, a representation in the bit rate ladder is determined such that it leads to one of the quality levels. A bit rate presently refers to the bit rate of an encoded video sequence (or video section). The spatial resolution refers to the number of sample values, or pixels, in the horizontal and vertical direction that the video sequence (or video section) has. A specific codec or encoder 150 typically allows for the adjustment of the bit rate. The bit rate ladder can therefore be determined by testing different bit rate settings. The video is encoded with each of the bit rate settings and the quality is determined. Then the bit rates whose qualities are closest to the predetermined quality levels are selected. However, such a procedure can require a plurality of encodings until a suitable bit rate ladder has been found. It would be desirable to reduce the number of encodings. In FIG. 1, this search for the bit rates is shown by loop 121—device 120 configures the bit rate settings and the video sections to be encoded for encoder 150, and encoder 150 outputs an encoded bit stream, which is decoded by a decoder 155. The quality of the decoded video section is determined. The quality determination can still be performed in decoder 155 or in device 120 based on the decoded video section.

It is to be noted that different video sequences (e.g., with different contents) can lead to different qualities after encoding and decoding (also referred to as reconstruction) even with the same bit rate setting. Therefore, determining the bit rate ladder can be performed based on a plurality of encoded video sections 101 (provided as input 140 of encoder 150). In addition, an encoder 150 does not need to directly support a bit rate input. The bit rate setting can be done indirectly, e.g., by setting the spatial (or temporal) resolution of the video, the quantization step (i.e., the quantization step width), the bit depth, or by other encoding parameters. The above-mentioned provisions are functional and can all be implemented in any software and/or hardware. Streaming services use adaptive bit rates (ABR) to offer end users with different bandwidths the different quality levels of the video signal. In ABR streaming, the video signal is encoded with different bit rates R₁, . . . , Rₖ, . . . , R_{K}. These different bit rates R₁, . . . , Rₖ, . . . , R_{K} correspond to different quality levels Q₁, . . . , Qₖ, . . . , Q_{K}. An encoded video signal of a certain bit rate and associated the quality level is a representation (Rₖ, Qₖ) and the set of all K representations is (R₁, Q₁), . . . , (R_{K}, Q_{K}) a bit rate ladder.

Quality Q of a digital video signal increases with the bit rate R, as shown in FIG. 2. Furthermore, the quality associated with a bit rate can depend on the content of the video section. A more complex content of a video signal with low redundancy typically has a lower quality than a content with higher redundancy at the same bit rate.

The video signal can be scaled before encoding to obtain a different (spatial) resolution. For example, a video signal has an original resolution of 1920×1080 pixels which is scaled to obtain a lower spatial resolution, e.g., 640×360. Scaling can entail, for example, dropping pixels (downsampling), often in combination with prior low-pass filtering, and/or interpolation of the pixels.

In such a case, quality Q can additionally depend on this resolution S. In other words, the quality can be specified as a function of the bit rate and the resolution: Q(R,S).

As a result, a bit rate ladder can be extended to comprise the resolution as an additional parameter: a representation k can be specified in dependence of the bit rate Rₖ and the resolution Sₖ as (Rₖ, Sₖ, Qₖ (Rₖ, Sₖ)).

If predefined bit rates are used for all video content to create a bit rate ladder, this leads to the data rate or storage being wasted for less complex content. It can also happen that not enough data rate is provided for more complex content, which leads to a reduction in the subjective quality (as perceived by viewers (users)).

Content-dependent bit rate ladders can be optimized for complete video content, such as a complete film (per-title encoding) or for finer subdivisions, e.g., for video sections, e.g., individual scenes of a film (per-scene encoding). By taking the resulting quality into account, the data rate as well as the storage space can be saved.

K bit rates in the bit rate ladder are sorted, for example, as follows: R₁< . . . <Rₖ< . . . <R_{K}. Accordingly, the following is true for the associated quality levels Q₁< . . . <Qₖ< . . . <Q_{K}. K spatial resolutions are preferably sorted such that S₁≤ . . . ≤Sₖ≤ . . . ≤S_{K} is true. If the representations are not available in this sorting, then they can be added to this sorting by re-sorting. The present disclosure therefore also applies to all sortings.

Every end user device can request and stream content from a content delivery network (CDN) having a bit rate that is suitable for the individual transmission rate T of the user's Internet connection. There is a plurality of possible selection strategies for a suitable bit rate. For example, the highest possible bit rate that is smaller than the individual transmission rate T can be selected, i.e.,

$${R}_{p} ( T ) = {max}_{k = 1 , … , K \vert {R}_{k} \leq T} {R}_{k} .$$

Furthermore, it is possible, for example, to alternate between different representations, e.g., (Rₚ, Qₚ) and (Rₚ₊₁, Qₚ₊₁), after certain time periods in order to efficiently utilize the available transmission rate. The disclosure, however, is not restricted to these examples.

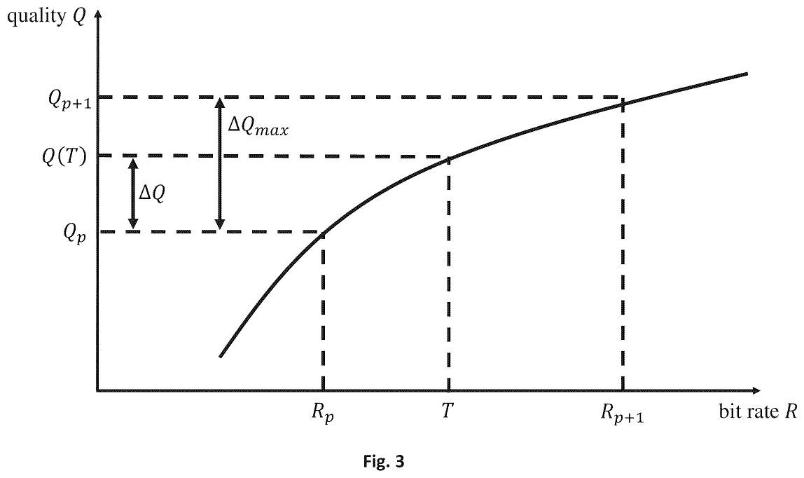

When using a set of representations with discrete bit rates R₁, . . . , Rₖ, . . . , R_{K}, the streamed video has a lower quality if the individual transmission rate T is not comprised in the set R₁, . . . , Rₖ, . . . , R_{K}. This difference defines the loss of quality

$$Δ Q ( T ) = Q ( T ) - Q ( {R}_{p} ( T ) )$$

where Q(T) denotes the quality level that the user could receive based on his individual transmission rate, and Q(Rₚ(T)) denotes the maximum quality level that the user can receive based on the discrete set of representations. This loss of quality is shown by way of example in FIG. 3.

In addition, a maximum loss of quality ΔQₘₐₓ can be defined. This maximum loss of quality denotes the difference in quality between two consecutive bit rates Rₚ and Rₚ₊₁ with the associated quality levels Qₚ and Qₚ₊₁,

$$Δ {Q}_{max} ( {Q}_{p} , {Q}_{p + 1} ) = {Q}_{p + 1} - {Q}_{p} .$$

FIG. 3 shows an example of such a maximum loss of quality. If there are significant differences between the quality levels of consecutive representations, a loss of quality ΔQ(T) can lead to a significant subjective loss of quality.

A large number of representations may be needed to minimize the maximum loss of quality for all users, where users of low bandwidths, e.g., in mobile networks, as well as users of high bandwidths, e.g., in connections via fiber optic cables, should be taken into account. However, this leads to high encoding and storage costs for the operators. Accordingly, the maximum loss of quality in a quality measure should be minimized taking into account the costs for encoding and storage.

To automate the creation of the set of representations, the subjective user perception is estimated by an objective quality measure. Such an objective quality measure can be an estimate of a subjective quality. Examples of objective quality measures that estimate subjective quality are VMAF, ITU-T P.1203 or structural similarity index (SSIM). However, the present disclosure is not restricted to the use of the examples mentioned and other, as well as non-standardized, quality measures can be used.

The quality measure can be a VMAF metric (Video Multi-Method Assessment Fusion, VMAF). The VMAF metric is an objective metric for the algorithmic assessment of image quality in videos. It evaluates a video that has been modified (for example by re-recoding and/or scaling) by comparing it to an undisturbed reference (original). The undisturbed reference (original representation) corresponds to the original video signal with an original resolution to be encoded.

The VMAF metric assigns a score between 0 and 100 to a video signal. A score of 0 corresponds to low estimated subjective quality, a score of 100 corresponds to high estimated subjective quality. The mean of the VMAF scores of all frames of a video signal is defined hereinafter as the VMAF score of the video signal. Quality Q corresponds to the VMAF score VMAF. This results in the quality difference

$$Δ VMAF ( T ) = VMAF ( T ) - VMAF ( {R}_{p} ( T ) ) .$$

The following describes determining quality levels by way of example. When using a quality measure such as the one described above, a bit rate ladder consisting of a set of representations can be created in such a way that a predefined maximum loss of quality is maintained between adjacent quality levels.

A minimum quality level Qₘᵢₙ and a maximum quality level Qₘₐₓ can be determined using a quality measure. A set of quality levels can be created based on the minimum or maximum quality level. This set of quality levels consists of Qₘₐₓ quality levels, where K≥2 is true.

The lowest quality level Q₁ is below the minimum quality level Qₘᵢₙ or is equal to the minimum quality level Qₘᵢₙ. Q₁≤Qₘᵢₙ is true. The highest quality level Q₁≤Qₘᵢₙ is above the maximum quality level Qₘₐₓ or is equal to the maximum quality level Qₘₐₓ. Q_{K}≥Qₘₐₓ is true.

In other words, the value range between the lowest and the highest quality level Q₁≤Qₘᵢₙ<Qₖ<Qₘₐₓ≤Q_{K} in this exemplary determination of quality requirements is divided into sections that do not exceed the maximum quality difference. The maximum quality difference between each pair of directly consecutive representations (Rₖ, Qₖ) and (Rₖ₊₁, Qₖ₊₁) is less than or equal to ΔQₘₐₓ for all transmission rates T in the value range R₁≤T≤R_{K}.

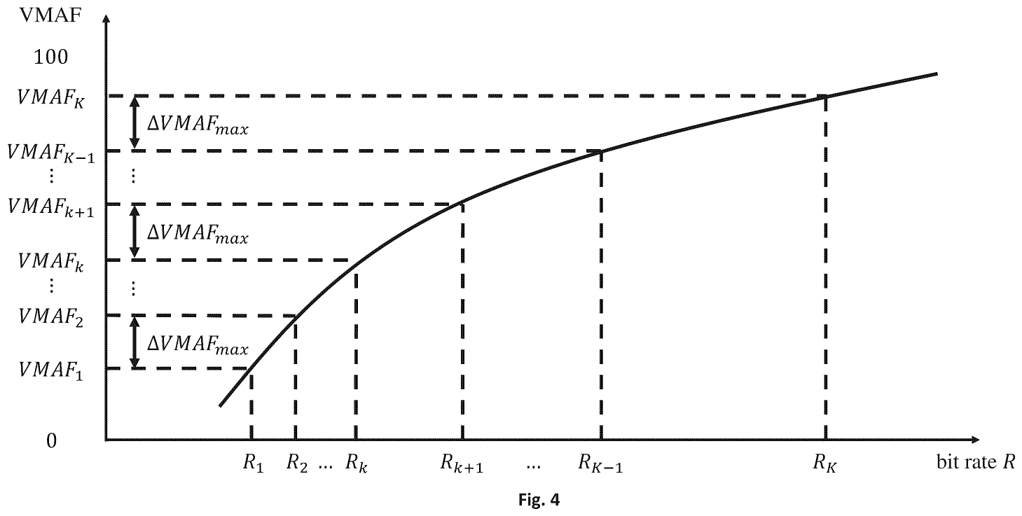

The classification based on such a maximum quality difference is shown in FIG. 4 as an example of a VMAF score.

The maximum quality level can be determined based on a quality at which a predetermined number of viewers cannot distinguish the representation corresponding to the quality from an original representation.

The predetermined number of viewers can arise from standardized test methods. One example is the well-known and standardized Double Stimulus Impairment test method according to ITU-R BT.500 (ITU-R., “Rec. BT.500-14: Methodologies for the subjective assessment of the quality of television images” (2019)). However, the present disclosure is not restricted to the use of the example mentioned. A different methodology can be determined and applied.

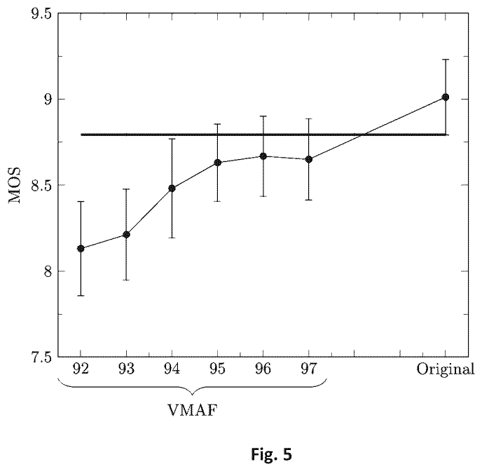

FIG. 5 shows an exemplary determination of the maximum quality level. In order to obtain a possible set of scores on the VMAF scale, tests were carried out with test subjects. Based on the determined mean opinion score (MOS) for various VMAF scores of test video sequences, an example of a smallest possible maximum quality level is obtained by a VMAF score of 95. In this example, the MOS is given on a scale between 0 (very disturbing impairments) and 10 (imperceptible impairments).

The minimum quality level Qₘᵢₙ can be determined using an acceptance measure. This acceptance measure can indicate a minimum quality at which a predetermined number of viewers find the representation associated with the minimum quality acceptable.

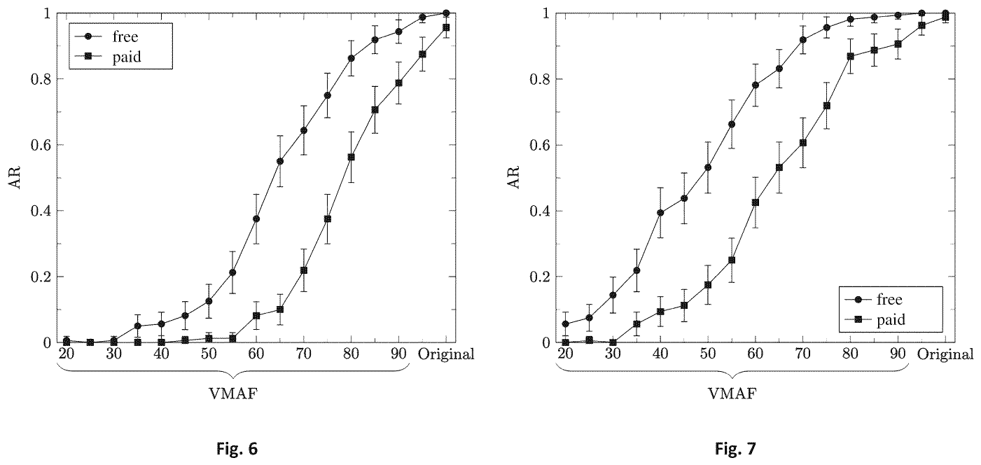

An exemplary determination of the maximum quality level is shown in FIGS. 6 and 7. FIG. 6 shows an exemplary acceptance rate for video sequences that are longer than 30 seconds. A distinction is made between free and paid streaming offers. FIG. 7 shows an exemplary acceptance rate for video sequences that are shorter than 30 seconds. Acceptance is denoted by 0 (unacceptable subjective quality) or 1 (acceptable subjective quality). The acceptance rate arises from the mean value for all test subjects.

If an acceptance rate of 0.5 is demanded, a possible minimum quality level of 55 on the VMAF scale was obtained. This lower limit can be changed by other criteria. For example, the minimum score on the VMAF scale for a first streaming service should be 10 to 15 higher than for a second streaming service. For video sequences longer than 30 seconds, the minimum VMAF quality level should be 70 for streaming services of the second type or 85 for streaming services of the first type. The first and the second streaming service can be a paid or free streaming service, respectively, but they do not have to be a paid or free streaming service.

A minimum number of quality levels can be determined by the maximum quality level, the minimum quality level, and the maximum quality gap. The minimum number can arise from the creation of the quality levels.

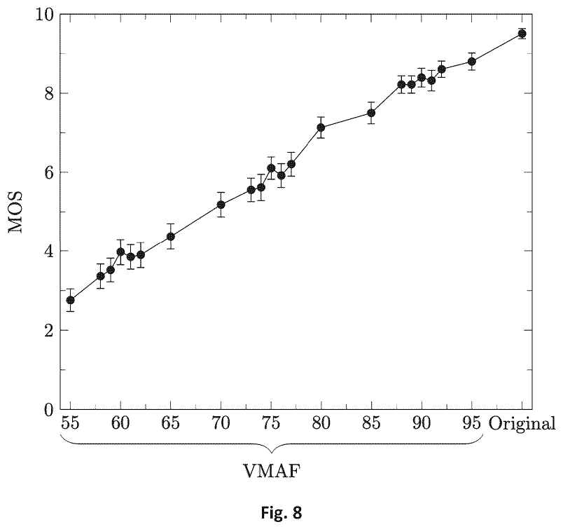

A relationship determined between the VMAF score and the MOS is approximately linear, which justifies a constant maximum quality difference for all adjacent pairs in the set of representations. This approximately linear relationship is shown by way of example in FIG. 8 in a MOS-VMAF diagram.

The maximum quality difference can be chosen such that a subjective quality of the video signal for Rₖ and Rₖ₊₁ is the same for a predetermined number of viewers. To determine the maximum quality difference ΔQₘₐₓ, all pairs of the VMAF score and associated opinion score (OS) can be evaluated using the example of the VMAF metric. The lower VMAF score is denoted by VMAFₗ and the higher VMAF score is denoted by VMAFₕ. This results in values for maximum quality differences

$$Δ {VMAF}_{max} = {VMAF}_{h} - {VMAF}_{l} .$$

ΔVMAFₘₐₓ can be determined, for example, using FIG. 8. Non-overlapping confidence intervals of the measured MOS values can mean that the quality can be distinguished. Accordingly, ΔVMAFₘₐₓ can be chosen to be large enough so that overlapping confidence intervals of the measured MOS values arise in order to achieve identical subjective quality. The maximum quality distance can result in a distance of ΔVMAFₘₐₓ=2.

At least 21 quality levels arise for a maximum quality level of 95 on the VMAF scale, a minimum quality level of 55 and a maximum quality distance of 2. However, the present disclosure is not restricted to the use of the exemplary values mentioned. Using a different quality measure can result in different values.

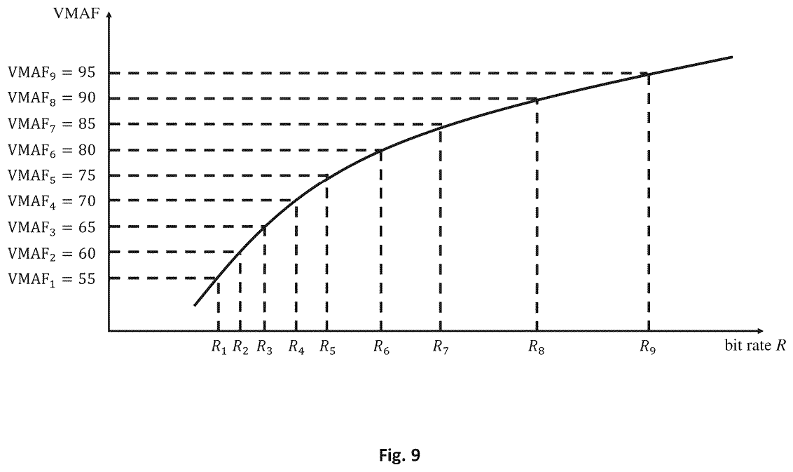

FIG. 9 shows an exemplary classification in a VMAF bit rate diagram. For reasons of clarity, a maximum quality distance of 5 on the VMAF scale was chosen in this example. In this example, nine quality levels arise in the value range that comprises the minimum and maximum quality levels. However, this exemplary representation does not correspond to an ideal set of quality levels, since quality differences between the levels can be noticeable. However, it is possible that the representation corresponds to a practical set.

As mentioned above, a specific codec or encoder 150 typically allows for setting the desired bit rate, but not directly setting a target quality. Testing different bit rate settings typically requires encoding a video with each of these bit rate settings and determining the associated quality. It is desirable to minimize the number of such test encodings in order to reduce the processing effort. At the same time, it is desirable to adhere to predetermined quality requirements and also to minimize the storage requirement.

The quality requirements can comprise quality levels. These quality levels can be determined, for example, by a maximum target quality Qₘₐₓ, a minimum target quality Qₘᵢₙ and a maximum quality distance ΔQₘₐₓ. Such quality levels can be generated, for example, according to the method in the section determining quality levels herein. In the case of the VMAF metric mentioned above, target quality levels can be obtained, for example, according to the following values: VMAFₘₐₓ=95, VMAFₘᵢₙ=79 and ΔVMAFₘₐₓ=2. The present disclosure is not restricted to these exemplary values, for example ΔVMAFₘₐₓ can also depend on the absolute VMAF value of the respective quality level.

Furthermore, the quality requirements can comprise one or more parameters ϵᵢ, the values of which indicate permissible deviations from target quality levels.

For example, the lowest quality level Q₁ in the bit rate ladder could deviate from the minimum target quality Qₘᵢₙ by a maximum of a predetermined value of a parameter ϵ₁: Qₘᵢₙ−ϵ₁≤Q₁≤Qₘᵢₙ. Similarly, the highest quality level Q_{K} in the bit rate ladder could deviate from the maximum target quality Qₘₐₓ by a maximum of a predetermined value of a parameter ϵ₂: Qₘₐₓ≤Q_{K}≤Qₘₐₓ+ϵ₂. The distance between two adjacent quality levels Qₖ and Qₖ₊₁ could be, for example, in a range determined by the maximum quality distance ΔQₘₐₓ and the value of a third parameter ϵ₂: ΔQₘₐₓ−ϵ₃≤Qₖ₊₁−Qₖ≤ΔQₘₐₓ. The values of the parameters ϵᵢ can differ or the values of the parameters ϵᵢ can be the same, i.e. ϵ₁=ϵ₂=ϵ₃=ϵ. The values are preferably all positive. The values ϵ₃ can also be different for each ϵ₃, i.e. ΔQₘₐₓ−ϵ_{3,k}≤Qₖ₊₁−Qₖ≤ΔQₘₐₓ. For example, possible values of the one or more parameters for the VMAF metric are located in an interval of [0.05; 0.5]. Smaller values can enable the creation of representations that are closer to the respective desired target quality, but a larger number of trial encodings can be needed to achieve this accuracy. On the other hand, larger permitted deviations enable a reduction in the number of trial encodings for creating a representation.

To create a bit rate ladder while taking quality requirements into account, a first set of reference points is determined. A reference point indicates a quality of a representation based on the bit rate and the resolution. In other words, a reference point is a tuple consisting of bit rate R, resolution S and the associated quality Q,(R,S,Q(R,S)).

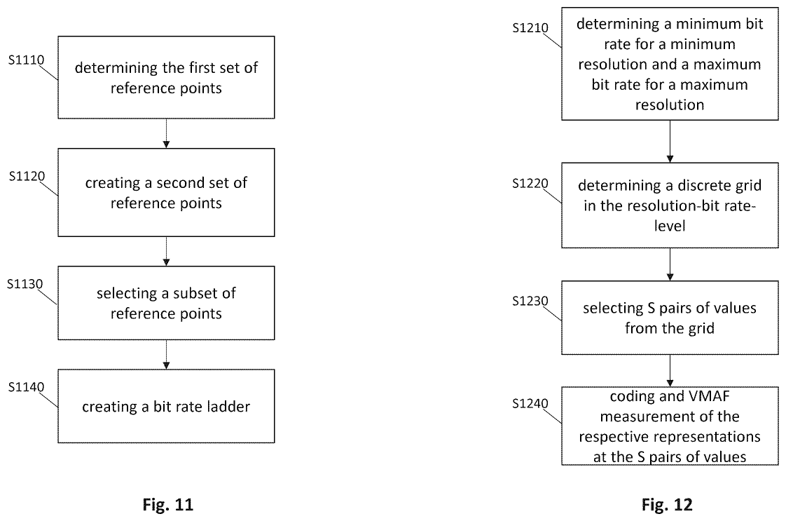

A method for creating a bit rate ladder is illustrated by way of example in the flow chart in FIG. 11.

The first set of reference points can be determined S1110 by selecting a group of pairs of values in a bit rate resolution space. Determining a first set of reference points is shown, for example, in the flow chart in FIG. 12.

The group of pairs of values can be arranged as a grid. For example, three bit rates and three resolutions can be selected to create a 3×3 grid of pairs of values (Rᵢ,Sⱼ). The grid can also be created with any other number of bit rates and/or any other number of resolutions. Such a grid can have any dimension N_{R}×N_{S}, where N_{R} and N_{S} are integers greater than or equal to 1.

For example, an N_{R} und N_{S} grid, e.g. a 5×5 grid, can be created from pairs of values (Rᵢ, Sⱼ) S1220. A subset of S reference points can be selected therefrom S1230. Such a subset can be, for example, a 3×3 grid, the main diagonal of the N_{R}×N_{S} grid, a chess board pattern, or the like.

The quality, which depends on bit rate R and resolution S of the (scaled and) encoded video section (representation), can be determined from the pairs of values selected S1240.

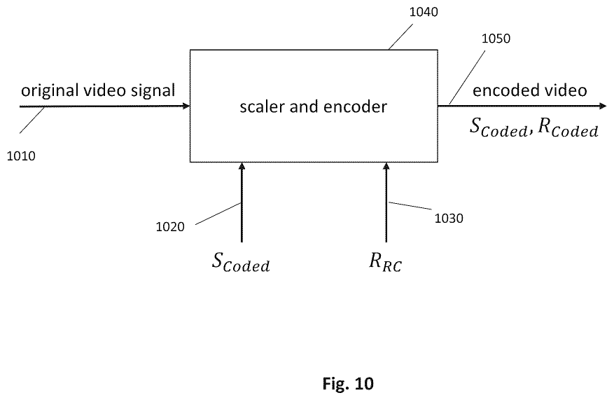

Determining comprises, for example, scaling and encoding the original video section (original representation) in the original resolution. An exemplary configuration of such an encoder is shown in FIG. 10. The original video section 1010 is scaled to obtain a resolution that differs from the original resolution. This target resolution S_{Coded} 1020 is an input parameter for scaler and encoder 1040.

Exemplary scaler and encoder 1040 also receives the associated bit rate of the pair of values as target bit rate R_{RC} 1130. Encoder 1040 creates an encoded representation 1050 with the resolution S_{Coded} and the bit rate R_{Coded}. The bit rate R_{Coded} of the encoded video signal 1050 can differ from the target bit rate R_{RC}. It is also possible that the encoder does not operate deterministically and that repeated encoding with the same parameters results in slightly different bit rates R_{Coded}. The scaler and the encoder do not necessarily have to be combined in one unit, as shown by way of example in FIG. 10. The scaler and the encoder can be separate units. For example, a scaler can output a video signal with a modified resolution and an encoder can receive a video section with a target resolution for encoding it.

In this example, the encoded representation is decoded and, if necessary, scaled to the original resolution. Such scaling (upsampling) can be obtained by interpolating, e.g., bicubic filtering, the decoded video signal. The decoded (and scaled) video section is compared with the original representation in order to determine an (objective) quality of the encoded representation. This objective quality can be specified, for example, using the VMAF metric or any other objective video metric.

In general, specifying a reference point does not necessarily require creating an encoded video section for determining the quality based on a comparison with an original representation. For example, a reference point can also be created in that an estimated quality Q s specified. An estimated quality can be obtained, for example, by interpolating, extrapolating, processing by a neural network, or the like.

The first grid, which comprises the bit rate resolution pairs of values for the first set of reference points, comprises at least the (predetermined) pairs of values
maximum bit rate R_{N}_{_{R}}, maximum resolution S_{N}_{_{S}}, and
minimum bit rate S_{N}_{_{S}}, minimum resolution S₁.

The maximum resolution typically corresponds to the original resolution. The minimum resolution corresponds, for example, to a predetermined resolution that is lower than the resolution of the original representation.

In an exemplary configuration, the minimum bit rate R₁ for the minimum resolution S₁ is determined S1210 taking quality requirements into account. The minimum bit rate can be selected such that a predetermined minimum quality is undercut. Likewise, the maximum bit rate R_{N}_{_{R}} for the maximum resolution Sys can be determined taking quality requirements into account. The maximum bit rate can be selected such that a predetermined maximum quality is exceeded.

As described above, the quality requirements can comprise at least two target quality levels that correspond to a minimum target quality Qₘᵢₙ and a maximum target quality Qₘₐₓ.

The minimum bit rate can be selected such that an associated representation for the smallest resolution S₁ delivers a quality Q(R₁,S₁) that is less than or equal to the minimum target quality and the permissible deviation ϵ₁: Q(R₁,S₁)≤Qₘᵢₙ−ϵ₁. The maximum bit rate can be selected such that an associated representation for the largest resolution S_{N}_{_{S}} delivers a quality Q(R_{N}_{_{R}},S₁) that is greater than or equal to the maximum target quality and the permissible deviation ϵ₂: Q(R_{N}_{_{R}},S_{N}_{_{S}})≥Qₘₐₓ+ϵ₂.

The other (N_{R}−2) bit rates R₂, . . . , R_{N}_{_{R}}₋₁ can be calculated, for example, as follows:

$$f ( {R}_{n} ) = f ( {R}_{n - 1} ) + \frac{f ( {R}_{{N}_{R}} ) - f ( {R}_{1} )}{{N}_{R} - 1} ,$$

where ƒ (bit rate) indicates that a function is applied to the bit rate. For example, the logarithm to base 2 can be used for this, i.e.,

$${log}_{2} ( \frac{{R}_{n}}{kbit / s} ) = {log}_{2} ( \frac{{R}_{n - 1}}{kbit / s} ) + \frac{{log}_{2} ( \frac{{R}_{{N}_{R}}}{kbit / s} ) - {log}_{2} ( \frac{{R}_{1}}{kbit / s} )}{{N}_{R} - 1}$$

In addition to the maximum and minimum resolution, further N_{S}−2 spatial resolutions S₂, . . . , S_{N}_{_{S}}−1 can be determined where it is to be true that each spatial resolution Sₙ should be greater than Sₙ₋₁. For example, typical local resolutions W×H, e.g., 1920×1080, 1280×720, 640×360, 320×180, 160×140 can be used.

An exemplary 5×5 grid can comprise resolutions having a width W at {512;768;1024;1280;1920} pixels. The bit rates of such a 5×5 grid can be arranged logarithmically between a predetermined minimum bit rate and a predetermined maximum bit rate. A predetermined minimum bit rate and a predetermined maximum bit rate can be determined, for example, based on quality requirements. In an exemplary implementation, R₁=250 kbit/s is used as the minimum bit rate and R₁=2000 kbit/s as the maximum bit rate. In this example, the logarithmically arranged further bit rates are R₂≈420 kbit/s l, R₃≈707 kbit/s und R₄≈1189 kbit/s. A subset of this 5×5 grid can be selected as the first set of reference points as described above. Alternatively, all pairs of values of the exemplary 5×5 grid can be used to determine the first set of reference points.

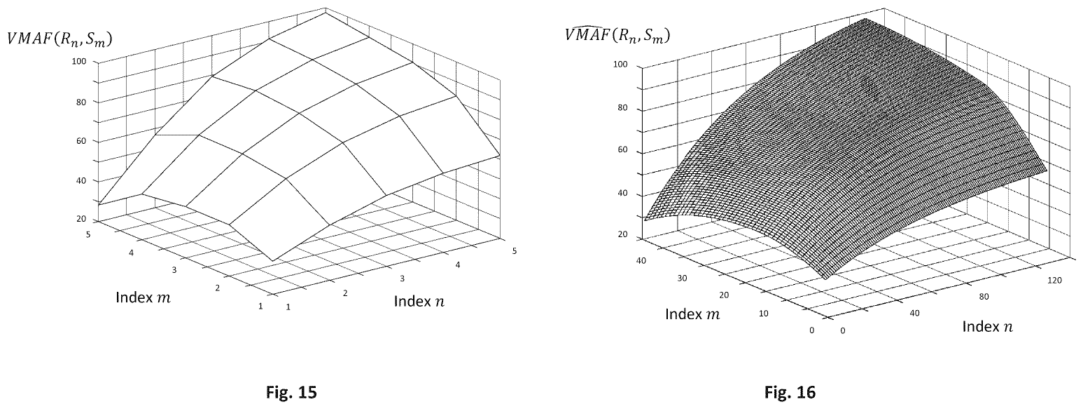

As described above, an encoded representation is created for each selected pair of values (Rᵢ, Sⱼ) and the quality is determined in order to create a respective reference point for the first set of reference points. A first set of reference points is shown by way of example in FIG. 15. The corners or crossing points of the grid illustrated represent the reference points (Rₙ, Sₘ, Q(Rₙ, Sₘ)) determined in the VMAF metric.

Based on the first set of reference points, a second set of reference points is created S1120, where the second set comprises more reference points than the first set. The second set can comprise one or more reference points of the first set. Preferably, all reference points of the first set are comprised in the second set.

Creating the second set of reference points comprises, for example, predicting (creating) qualities Q for pairs of values (Rᵢ, Sⱼ) in the bit rate resolution space that are not comprised in the first set of reference points. Creating comprises, for example, interpolating, extrapolating, processing by a neural network, a combination thereof, or other methods for generating additional reference points based on the first set of reference points. A secondary condition for a prediction comprises, for example, that for each resolution Sₘ, the quality also increases with the increasing bit rate: VMAF(Rₙ, Sₘ)>VMAF(Rₙ₋₁, Sₘ).

To create the second set of reference points, a second grid of pairs of values can be created. The second grid can have, for example, an arbitrary dimension M_{R}×M_{S}, where M_{R}≥N_{R} and M_{S}≥N_{S} is true. An exemplary second grid comprises the pairs of values of the first set. For example, such a second grid comprises 45 resolutions and 129 bit rates. The present disclosure is not restricted to these exemplary numerical values. As described above, the second grid can comprise any number of pairs of values that is greater than the number of pairs of values in the first set.

The qualities Q at the pairs of values of the second set are created (predicated) based on the reference points of the first set. The reference points of the first set comprise, as described above, the qualities Q determined at the pairs of values of the first set.

As already indicated, creating qualities Q for the pairs of values of the second set can comprise at least one of the following: interpolating the reference points and/or processing by a neural network, and/or a combination thereof.

In the above-mentioned exemplary second grid with 45 resolutions and 129 bit rates, 5805 estimated qualities are then created.

In a first exemplary embodiment, the reference points of the first set are interpolated to obtain (estimated) qualities Q at the pairs of values of the second set. An interpolation for the resolution can be performed, for example, by a cubic interpolation polynomial. An interpolation for the bit rate can be performed, for example, by a power series model with one or more terms.

In a second exemplary embodiment, the reference points of the first set are processed by a neural network to obtain estimated qualities Q at the pairs of values of the second set. For example, the neural network receives the reference points of the first set as input data, where the reference points each comprise a bit rate; a resolution and the associated determined (measured) quality Q. In addition, the neural network can receive the pairs of values of the second set as input parameters. The neural network is trained, for example, such that it outputs estimated qualities Q for the pairs of values of the second set. The neural network processes the input data through one or more layers to create output data. The output data comprises estimated qualities Q at the pairs of values of the second set.

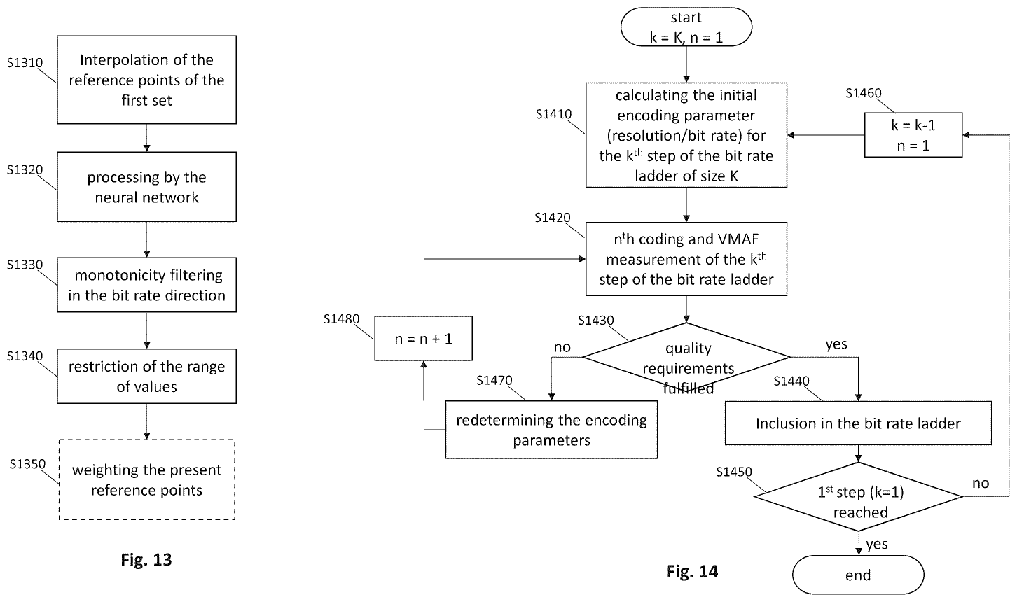

In a third exemplary embodiment, shown in the flow chart in FIG. 13, the reference points of the first set are interpolated S1310, analogously to the first exemplary embodiment, to obtain estimated qualities Q at the pairs of values of the second set. This estimate can be refined by using the reference points of the first set as input data of a neural network. Such a neural network is trained, for example, such that it improves (refines) the qualities Q estimated by the interpolation. The neural network processes S1320 the input data through one or more layers to create output data. The output data comprises estimated qualities Q at the pairs of values of the second set.

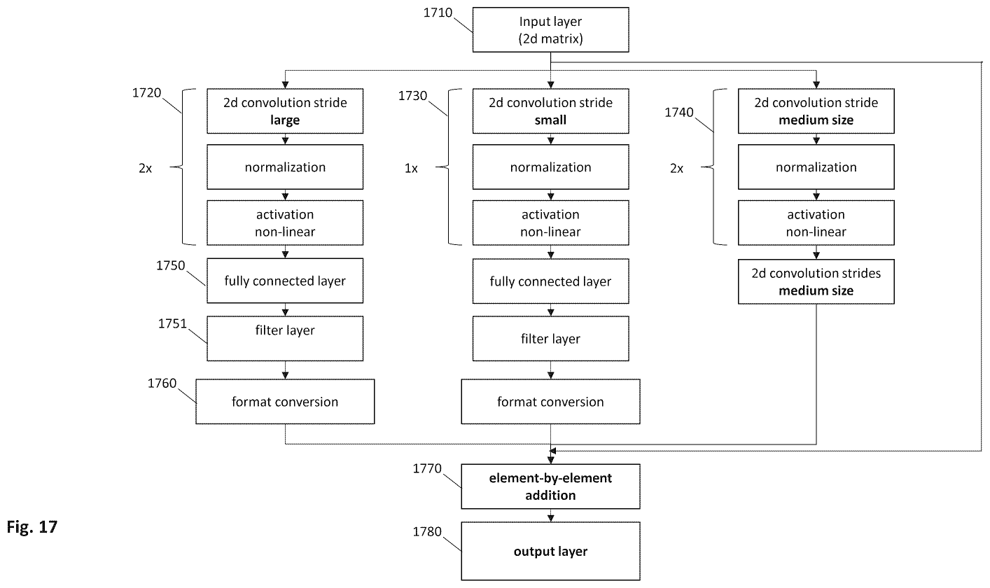

An exemplary structure of a neural network is shown in FIG. 17. An input layer 1710 receives the input data as a two-dimensional matrix. A neural network can comprise, for example, one or more convolutional layers that can operate with different convolution matrices (kernels) and step sizes (strides) of different sizes. Normalizing the output of a convolutional layer can increase its efficiency. Typically, a (normalized) output of such a convolution is processed by a non-linear activation function. Several blocks 1720, 1730, 1740 consisting of a convolution, a normalization, and a non-linear activation can be applied both in parallel as well as in series. A possible application in series is indicated in FIG. 17 by “1×”, “2×”, etc. For example, a normalization can be applied to a small number of data sets of the preceding layer (batch normalization). A nonlinear activation function is, for example, a sigmoid function, a hyperbolic tangent, or a rectifier (rectified linear unit, ReLU). The neural network can also comprise fully connected layers 1750 and further filters 1751, which, for example, can reduce the dimension of the weights and/or deactivate individual neurons of a preceding layer (drop out layer). Further layers 1760 can create the desired dimension of the output data (depth to space). Possible data created in parallel can be combined by the addition of element by element 1770. An output layer 1780 creates the output data described above.

However, the present disclosure is not restricted to a network of this exemplary structure. In general, the neural network can comprise any combination of (different) layers that creates the desired output data from the input data described above. Although convolutional networks can be advantageous due to their ability to effectively compress two-dimensional correlated data, the present disclosure, however, is not restricted to the use of convolutional networks.

The output data of a neural network can be further processed by filtering and/or limiting the value range of the predicted (estimated) qualities.

In an exemplary implementation, monotonicity conditions can be complied with by filtering S1330. Such a monotonicity condition comprises, for example, that for each resolution Sₘ, the quality also increases with an increasing bit rate: VMAF(Rₙ, Sₘ)>VMAF(Rₙ₋₁,Sₘ). This can be achieved, for example, by local (low-pass) filtering.

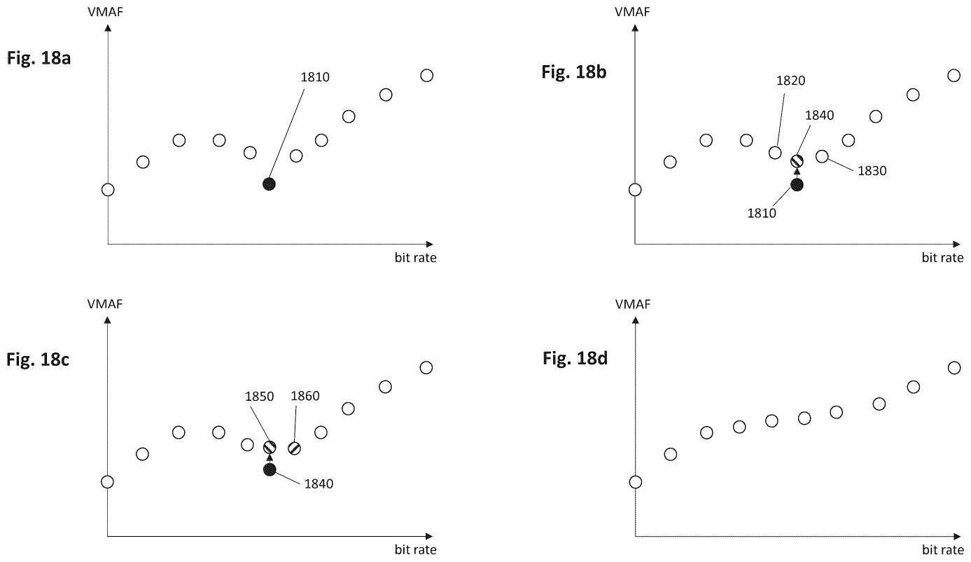

FIGS. 18a-d show exemplary filtering using the VMAF metric. If, like in FIG. 18a, a minimum 1810 can be found, e.g. by a change in sign of the gradient, a new quality value VMAF_{new} 1840 can be determined from the old value VMAF_{old} 1810 and the two adjacent values VMAF_{N}_{₁} 1820 and VMAF_{N}_{₂} 1830, e.g. VMAF_{new}=0.50 VMAF_{old}+0.25 VMAF_{N}_{₁}+0.25 VMAF_{N}_{₂}. The adjustment of a value is shown in FIG. 18b. If the new value 1840 again represents a minimum, the step is repeated to obtain another new value 1850, as shown in FIG. 18c. The quality as a function of the bit rate can now have a minimum at a further point 1860. Determining a new quality value is repeated until the function no longer has a minimum, as shown in FIG. 18d. The quality as a function of the bit rate is thus increasing monotonically.

For example, the range of values of the predicted qualities can be limited S1340. It is possible that the neural network estimates quality values that are disposed outside the range of values of the quality measure used. The VMAF metric, for example, allows values between 0 and 100 and can be limited as follows:

$$( {R}_{n} , {S}_{m} ) = \{ \begin{matrix}100 & ; & ( {R}_{n} , {S}_{m} ) > 100 \\ 0 & ; & ( {R}_{n} , {S}_{m} ) < 0 \\ ( {R}_{n} , {S}_{m} ) & ; & otherwise\end{matrix}$$

A second set of reference points is shown by way of example in FIG. 16. The corners or crossing points of the grid illustrated represent the reference points created (Rₙ, Sₘ, \hat{Q}(Rₙ, Sₘ)) with the estimated qualities \hat{Q} in the VMAF metric.

The reference points can be, for example, additionally weighted S1350 by predetermined criteria, such as the bit rate, the expected coding time, or the spatial resolution.

A subset of reference points is selected S1130 from the reference points of the second set, taking quality requirements into account, in order to create the bit rate ladder S1140. FIG. 14 shows an exemplary flow chart for creating the bit rate ladder from the reference points of the second set.

As described above, the quality requirements can comprise at least two target quality levels that correspond to a minimum target quality Qₘᵢₙ and a maximum target quality Qₘₐₓ. In addition, the quality requirements can comprise further target quality levels that are defined, for example, by a maximum quality distance between two adjacent quality levels, as described above. Alternatively, further target quality levels can also be explicitly specified in the quality measure used.

A representation can be determined and comprised in the bit rate ladder for each of the K target quality levels from the quality requirements. Determining the representation shall be described below using an example for a current k^{th} target quality level. Representations for further quality levels can be created analogously. The bit rate ladder can be created both starting from the minimum target quality Qₘᵢₙ as well as starting from the maximum target quality Qₘₐₓ. FIG. 14 shows an exemplary flow chart for creating the bit rate ladder starting out from the maximum target quality Qₘₐₓ, i.e., starting with the K^{th} level of the bit rate ladder.

Initial encoding parameters, e.g., the resolution and the bit rate specification, are calculated S1410 for a current level from the target quality levels. For this, a bit rate is determined for a bit rate specification of an encoder. For each resolution of the second set, a bit rate is determined whose predicted quality meets the quality requirements. There can be spatial resolutions whose associated qualities do not meet the quality requirements. They are not taken into account when selecting a bit rate specification. Furthermore, further ancillary conditions with regard to the spatial resolution can also be specified. For example, only spatial resolutions that have a minimum size can be taken into account, e.g., all spatial resolutions above 1280×720 sample values. However, only spatial resolutions that are less than or equal to a specified size can be taken into account, e.g., all spatial resolutions less than or equal to 1280×720 sample values.

The quality requirements for certain (measured) qualities Q as well as for predicted qualities Q comprise, for example, the conditions described above:

$$\begin{matrix}{Q}_{min} - {ϵ}_{1} \leq {Q}_{1} \leq {Q}_{min} \\ {Q}_{max} \leq {Q}_{K} \leq {Q}_{max} + {ϵ}_{2} , \\ Δ {Q}_{max} - {ϵ}_{3} \leq {Q}_{k + 1} - {Q}_{k} \leq Δ {Q}_{max} .\end{matrix}$$

The smallest bit rate is selected from the bit rates determined in this manner as the bit rate specification. The resolution associated with the selected bit rate is used as the target resolution. When selecting the bit rate for the k^{th} level of K quality levels, it can also be taken into account that the spatial resolution Sₖ for increasing quality Q₁< . . . <Qₖ< . . . <Q_{K} should not become lower S₁≤ . . . ≤Sₖ≤ . . . ≤S_{K}.

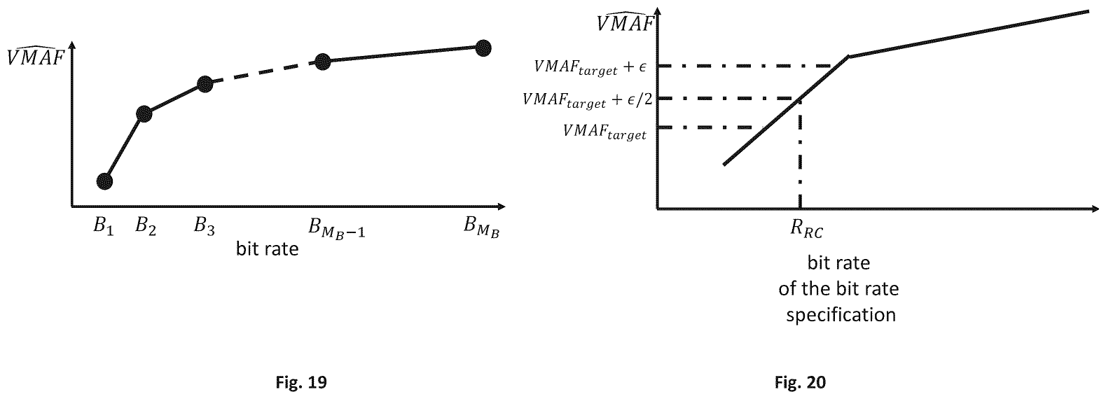

Determining the bit rate for the bit rate specification comprises, for example, an interpolation based on the reference points of the second set. For example, as shown in FIG. 19 for the estimated values VMAF metric, an interpolation of the (estimated) quality can be performed as a function of the bit rate at a constant resolution Sₘ. Such an interpolation can be, for example, a linear interpolation.

FIG. 20 shows an example of determining a bit rate specification (rate control) R_{RC} for a target quality in the range between VMAF_{target} and VMAF_{target}+ϵ. The bit rate specification R_{RC} is selected such that the value of the quality is VMAF_{target}+ϵ/2, where this value was determined by interpolating the predicted qualities. This increases the probability that the actual quality is in the desired range.

A representation can be created for the current target quality level from the quality requirements. This comprises encoding S1420 the video section with the respective selected bit rate specification. If necessary, the video section can be scaled to the associated spatial resolution prior to encoding.

Quality Q can be determined (measured) from the representation created. This can be done, as described above, by an objective comparison with the original representation. Quality Q determined can be compared with the quality requirements S1430.

If the quality determined meets the quality requirements (“Yes” in S1430), then the representation can be comprised in the bit rate ladder S1440. After the representation for the current k^{th} target quality level has been comprised in the bit rate ladder, a representation for the (k−1)^{th} target quality level can be determined S1460 in a similar way, provided that the lowest target level of the bit rate ladder has not yet been reached (“No” in S1450), i.e., k>1 is true. If k=1 (“Yes” in S1450) is true, then the bit rate ladder has been fully created and the exemplary flow in FIG. 14 is terminated.

The further representations to be created are determined on the basis of the respective preceding representation comprised in the bit rate ladder. This can be achieved by the quality requirement for adjacent quality levels ΔQₘₐₓ−ϵ₃≤Qₖ₊₁−Qₖ≤ΔQₘₐₓ, which takes into account the maximum quality difference ΔQₘₐₓ and the associated permissible deviation ϵ₃. Furthermore, the spatial resolution Sₖ should not become lower for increasing quality.

If the determined quality of the created representation does not meet the quality requirements (“No” in S1430), then a new representation can be determined based on a new bit rate specification. To re-determine the encoding parameters S1470, for example, the (estimated) quality as a function of the bit rate, which is shown by way of example in FIG. 19, can be supplemented by the new measured quality of the representation created. For example, the interpolation described in detail with reference to FIG. 20 can be repeated with the added (determined) quality value. For example, with the added (determined) quality value, a bilinear interpolation can be performed between the already encoded and predicted reference points in order to reduce possible deviations from estimated and determined quality values. A further representation is created in the loop S1480 with the newly determined encoding parameters.

This creation of representations and comparisons of the respective qualities determined with the quality requirements can be repeated until a representation is created that complies with the quality requirements.

Creating (estimated) qualities Q enables an improved determination of encoding parameters and can thus reduce the number of trial encodings required for creating a representation of the bit rate ladder. The number of trial encodings required can depend on the permissible deviations ϵᵢ from target quality levels.

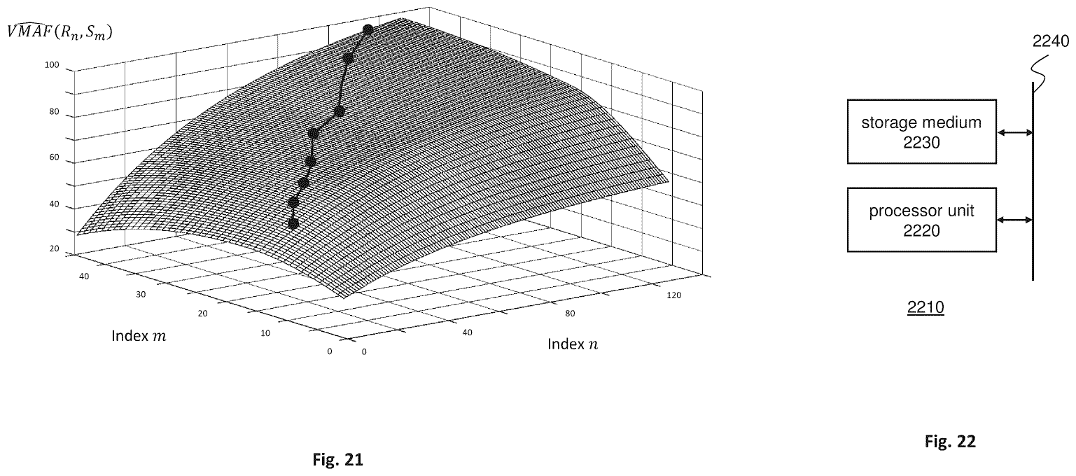

An exemplary bit rate ladder is illustrated in FIG. 21. The dots mark the quality levels of the bit rate ladder.

The exemplary embodiments described for creating a bit rate ladder can be combined at random, unless explicitly stated otherwise.

A bit rate ladder created as described above can be used to encode representations of a further video section. In other words, the bit rate ladder created can be used to encode one or more other video sections. The bit rate ladder created comprises two or more quality levels. A representation of the further video section can be created for each of the quality levels of the bit rate ladder. Creating comprises encoding the further video section according to the respective quality level. The quality level comprises an associated target bit rate and a target resolution.

Although the embodiments of the disclosure have been described based on encoding video data, the disclosure is not restricted thereto but can also be used for encoding still images.

Embodiments of the present disclosure and their functions can be implemented in hardware, software, firmware, or a combination thereof, as shown by way of example in FIG. 22. When embodiments are implemented in software, the functions can be stored on a computer-readable storage medium 2230 or transmitted over a communication channel 2240 (e.g., a bus) as instructions or code that is executed by a hardware-based processor unit 2220. For example, a computer-readable storage medium 1130 can be RAM, ROM, EEPROM, CD-ROM, or other optical storage medium, a magnetic storage medium, flash storage, or other storage medium that can be used to store program code in the form of instructions such that they can be read out by a computer.

Instructions can be executed by one or more processors, such as digital signal processors (DSP), general purpose microprocessors, application-specific integrated circuits, field-programmable gate arrays (FPGAs), or other integrated or discrete logic circuits. Accordingly, the term “processor” can refer to any of the structures mentioned or other structures suitable for implementing the methods described above. In addition, the functionalities described can be implemented in hardware and/or software modules provided for this purpose which are configured to encode and/or decode image data, also as part of a combined codec. The methods can also be implemented in one or more circuits or logic elements.

Processor 2220 can thus implement device 110 or 120, or device 100 for determining a bit rate ladder.

A device for determining the quality requirements for encoding representations of a video section comprises a unit which determines the maximum and the minimum quality level as described above, and a unit which determines the set of quality levels with a predefined, maximum quality distance between adjacent quality levels as described above.

A device for creating a bit rate ladder for encoding representations of a video section comprises a unit for determining a first set of reference points, where a reference point indicates a quality of a representation based on the bit rate and the resolution, and the quality is based on a comparison with an original representation, a unit for creating a second set of reference points based on the first set of reference points, where the second set comprises more reference points than the first set, and a unit for selecting a subset of reference points of the second set taking into account quality requirements for generating the bit rate ladder based on the subset of reference points.

A device for encoding representations of a video section comprises a unit that creates the bit rate ladder as described above and a unit for creating a representation for each of the quality levels of the bit rate ladder, comprising encoding the video section according to the respective quality level.

In summary, the present disclosure relates to methods and devices for creating a bit rate ladder for encoding representations of a video section. Creating comprises generating a set of references points, where a reference point indicates a quality of a representation based on the bit rate and the resolution. A subset of references points is selected for creating the bit rate ladder while taking quality requirements into account.

1. A method for creating a bit rate ladder for encoding representations of a video section, comprising:
determining a first set of reference points, wherein a reference point indicates a quality of a representation based on a bit rate and a resolution and the quality is based on a comparison with an original representation;
creating a second set of reference points based on the first set of reference points, wherein the second set comprises more reference points than the first set, and
selecting a subset of reference points of the second set while taking quality requirements into account for creating the bit rate ladder based on the subset of reference points.

2. The method according to claim 1, wherein
determining the first set of reference points comprises:
selecting a first grid of pairs of values in a bit rate resolution space, and determining qualities of representations at the pairs of values of the first grid to obtain a first set of reference points.

3. The method according to claim 2, wherein:
the first grid comprises at least the predetermined pairs of values
maximum bit rate, maximum resolution, and
minimum bit rate, minimum resolution,
wherein
the minimum bit rate for the minimum resolution is determined taking quality requirements into account,
the maximum bit rate for the maximum resolution is determined taking quality requirements into account,
the maximum resolution corresponds to a resolution of the original representation, and
the minimum resolution corresponds to a predetermined resolution that is lower than the resolution of the original representation.

4. The method according to claim 3, wherein:
the quality requirements comprise at least two target quality levels that correspond to a minimum target quality and a maximum target quality,
a quality of a representation that is created based on the minimum bit rate and the minimum resolution falls below the minimum target quality and
a quality of a representation that is created based on the maximum bit rate and the maximum resolution exceeds the maximum target quality.

5. The method according to claim 1, wherein creating the second set of reference points comprises:
creating a second grid of pairs of values in a bit rate resolution space that con pairs of values of the first set and
creating qualities for the pairs of values of the second set based on the reference points of the first set.

6. The method according to claim 5, wherein creating qualities for the pairs of values of the second set comprises at least one of the following:
interpolation of the reference points, and/or
processing by a neural network, and/or
a combination thereof.

7. The method according to claim 6, wherein processing by a neural network comprises:
obtaining reference points of the first set or an interpolation of reference points of the first set as input data, and
creating output data comprising processing the input data by one or more layers of the neural network.

8. The method according to claim 6, wherein output data of the neural network is processed by
filtering the output data to comply with monotonicity conditions, and/or
limiting the value range of the predicted qualities.

9. The method according to claim 1, wherein
the quality requirements comprises at least two target quality levels that correspond to a minimum target quality and a maximum target quality and
selecting the subset of reference points comprising:
determining a bit rate for a bit rate specification of an encoder for each target quality level from the quality requirements, comprising
determining a bit rate for each resolution, the associated predicted quality of which meets the quality requirements for the respective target quality level, and
selecting the minimum bit rate from the determined bit rates as the bit rate specification.

10. The method according to claim 9, wherein determining the bit rate for the bit rate specification comprises an interpolation based on the reference points of the second set.

11. The method according to claim 9, wherein selecting the subset of reference points further comprises:
creating a representation comprising encoding the video section with the respective bit rate specification for each target quality level from the quality requirements.

12. The method according to claim 11, further comprising:
determining a quality of the representation created, and
comparing the quality determined with the quality requirements,
if the quality determined meets the quality requirements: comprising the representation in the bit rate ladder;
if the quality determined does not meet the quality requirements: determining a new representation based on a new bit rate specification.

13. A method for encoding representations of a video section, comprising:
creating a bit rate ladder according to claim 1, wherein the bit rate ladder comprises two or more quality levels; and
for each of the quality levels of the bit rate ladder: creating a representation comprising encoding the video section according to the respective quality level.

14. At least one non-transitory, computer-readable medium, comprising instructions that, when executed by at least one processor, cause the at least one processor to perform the method of claim 1.

15. A device for creating a bit rate ladder for encoding representations of a video section, comprising:
at least one processor configured to:
determine a first set of reference points, wherein a reference point indicates a quality of a representation based on the bit rate and the resolution and the quality is based on a comparison with an original representation;
create a second set of reference points based on the first set of reference points, wherein the second set comprises more reference points than the first set, and
select a subset of reference points of the second set while taking quality requirements into account for creating the bit rate ladder based on the subset of reference points.

16. The device according to claim 15 wherein the at least one processor is further configured to:
create, for each of the quality levels of the bit rate ladder, a representation comprising encoding the video section according to the respective quality level.
